(19) United States
(12) Patent Application Publication
(10) Pub. No.: US 2026/0180651 A1
(43) Pub. Date: Jun. 25, 2026

(54) METHODS FOR CALCULATING CSI PROCESSING UNITS FOR AI/ML BEAM MANAGEMENT

(71) Applicant: InterDigital Patent Holdings, Inc., Wilmington, DE (US)

(72) Inventors: Young Woo Kwak, Woodbury, NY (US); Yugeswar Deenoo Narayanan Thangaraj, Chalfont, PA (US); Moon IL Lee, Melville, NY (US); Haseeb Ur Rehman, Winnipeg (CA); Patrick Tooher, Montreal (CA); Nazli Khan Beigi, Longueuil (CA)

(73) Assignee: InterDigital Patent Holdings, Inc., Wilmington, DE (US)

(21) Appl. No.: 18/990,854

(22) Filed: Dec. 20, 2024

(51) Int. Cl. H04B 7/06

(52) U.S. Cl. CPC H04B 7/0626

(57) ABSTRACT

A wireless transmit/receive unit (WTRU) may receive a plurality of channel state information (CSI) reporting configurations from a network. The WTRU may determine, based on the plurality of one or more CSI reporting configurations, a first type of CSI processing unit and/or a second type of CSI processing unit. The WTRU may determine a first and a second duration to occupy the first type and the second type of CSI processing unit needed to perform CSI reporting. The WTRU may determine a subset of the plurality of CSI reporting configurations based on the first duration, the number of the first type of CSI processing units needed to perform CSI reporting, the second duration, and/or the number of the second type of CSI processing units needed to perform CSI reporting. The WTRU may perform CSI reporting based on the subset of the one or more CSI reporting configurations.

### BACKGROUND

In radio access network (RAN) #102, a work item on AI/ML for new radio (NR) Air Interface was agreed with several objectives for general framework and model identification. Objectives for beam management (BM) include downlink (DL) transmission (Tx) beam prediction for both wireless transmit/receive unit (WTRU)-sided model and network (NW)-sided model, encompassing RAN1 and/or RAN2. Objectives for spatial-domain include DL Tx beam prediction for Set A of beams based on measurement results of Set B of beams (BM-Case 1). Objectives for temporal domain include DL Tx beam prediction for Set A of beams based on the historic measurement results of Set B of beams (BM-Case 2). Further objections include the need to specify necessary signaling and/or mechanism(s) to facilitate life cycle management (LCM) operations specific to the BM use cases, if any. Further objectives include enabling method(s) to ensure consistency between training and inference regarding NW-side additional conditions (if identified) for inference at the WTRU. The objectives further include striving for common framework design to support both BM-Case 1 and/or BM-Case 2. Herein described are solutions on DL Tx beam for both WTRU-sided model and NW-sided model in both spatial domain and temporal domain.

### SUMMARY

A wireless transmit/receive unit (WTRU) may receive a plurality of channel state information (CSI) reporting configurations from a network. The WTRU may determine, based on the plurality of one or more CSI reporting configurations, a first type of CSI processing unit and/or a second type of CSI processing unit. The WTRU may determine a first duration to occupy the first type of CSI processing unit needed to perform CSI reporting. The WTRU may determine a number of the first type of CSI processing units needed to perform CSI reporting. The WTRU may determine a second duration to occupy the second type of CSI processing unit needed to perform CSI reporting. The WTRU may determine a number of the second type of CSI processing units needed to perform CSI reporting. The WTRU may determine a subset of the plurality of CSI reporting configurations based on the first duration, the number of the first type of CSI processing units needed to perform CSI reporting, the second duration, and/or the number of the second type of CSI processing units needed to perform CSI reporting. The WTRU may perform CSI reporting based on the subset of the one or more CSI reporting configurations.

The first type of CSI processing unit may be associated with non-artificial intelligence/machine learning (AI/ML) based CSI reporting and the second type of CSI processing unit is associated with AI/ML based CSI reporting. The one or more CSI reporting configurations may comprise a CSI report quantity, a CSI report type, a CSI report codebook configuration, and/or a CSI report frequency.

The CSI report quantity may comprise one or more of a channel quality indicator (CQI), a rank indicator (RI), a precoding matrix indicator (PMI), a CSI-reference signal (RS) resource indicator (CRI), and/or a layer indicator (LI). The CSI report type is aperiodic, semi-persistent, or periodic.

The WTRU may determine a number of the first type of CSI processing units to activate for CSI reporting. The WTRU may determine a number of the second type of CSI processing units to activate for CSI reporting. The WTRU may determine the number of first and/or second type of CSI processing units based on one or more of a CSI report quantity, a CSI report type, a CSI report configuration type, a reference signal (RS) transmission type, a number of RS resources, and/or a number of RS ports.

The CSI report quantity may comprise a first type and/or a second type, where the first type of a CSI report quantity is based on the first type of CSI processing unit and/or the second type of a CSI report quantity is based on the second type of CSI processing unit. The number of RS ports may comprise one or more of the average, median, maximum allowable RS ports, or minimum allowable RS ports associated with each CSI report configuration. The WTRU may perform an update on the subset of the plurality of CSI reporting configurations.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a channel state information (CSI) processing unit (CPU) for normal CSI and beam management (BM)-Case 1.

FIG. 3 depicts CPU occupation for BM-Case 2.

FIG. 4 depicts CPU occupation type 1.

FIG. 5 depicts CPU occupation type 2.

FIG. 6 depicts CPU occupation type 3.

FIG. 7 depicts CPU occupation type 4.

FIG. 8 depicts CPU occupation type 5.

FIG. 9 depicts CPU occupation type 6.

FIG. 10 depicts CPU occupation type 7.

FIG. 11 depicts CPU occupation for BM-Case 1.

FIG. 12 depicts CPU occupation for BM-Case 2.

### DETAILED DESCRIPTION

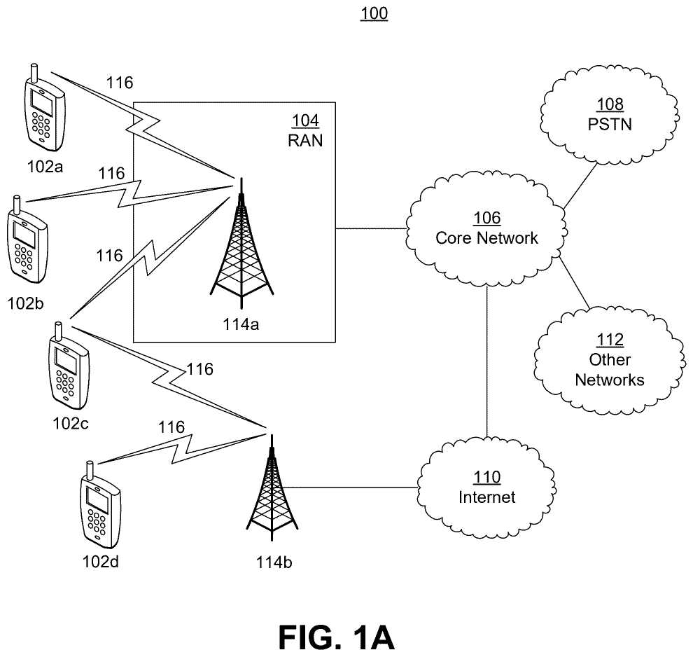

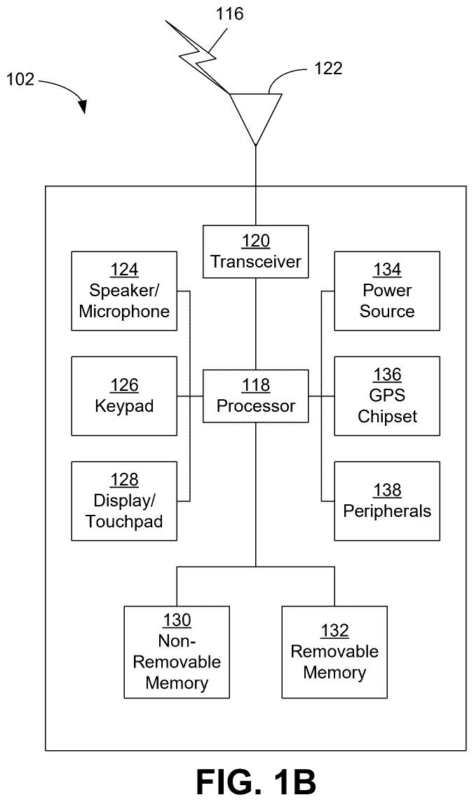

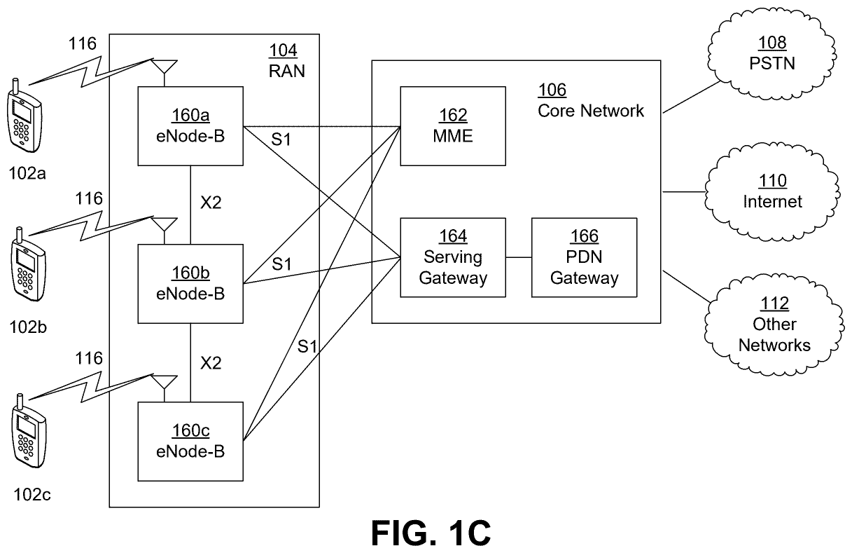

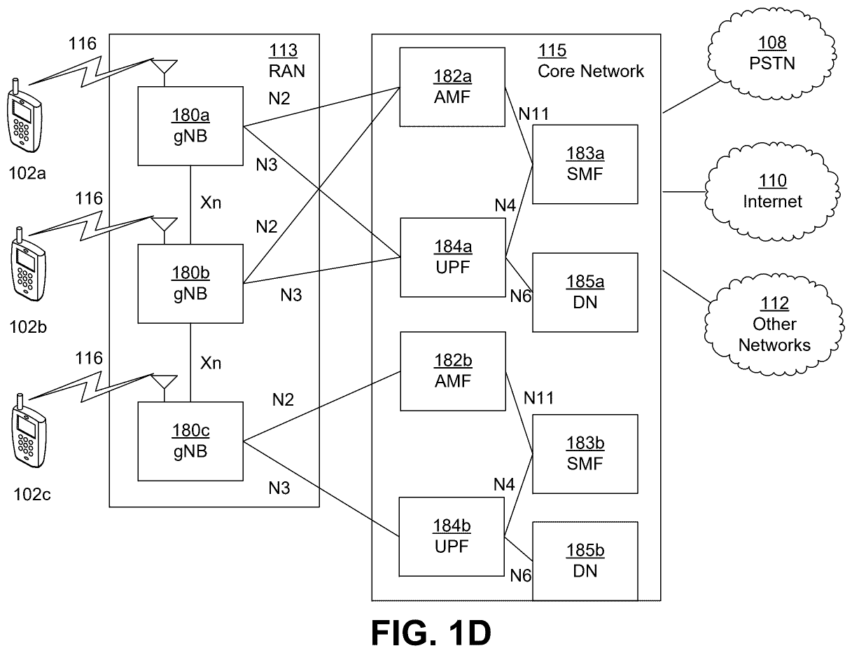

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be test equipment. Direct RF coupling and/or wireless communications via RF circuitry (e.g., which may include one or more antennas) may be used by the emulation devices to transmit and/or receive data.

Unlike traditional CSI reporting, beam reporting for beam management (BM)-Case 2 may take a long time for the reporting as measurement periodicity can be multiple of 60 millisecond (ms) plus additional calculation and/or prediction time. In the practical implementation, a wireless/transmit receive unit (WTRU), also known as a user equipment (UE) may not need to process channel state information (CSI) all the time. At least one CSI processing unit (CPU) may need to be occupied. At least one CPU may limit WTRU CSI reporting capability.

Described herein are solutions for how a WTRU may efficiently support CSI processing unit AI/ML BM reporting especially for BM-Case 2. A WTRU may determine a type of CPU and/or CPU occupation timing based on CSI report configurations and/or a type of CSI report configurations.

A WTRU may receive multiple CSI reporting configurations. Each CSI reporting configuration may include at least one or more of the following parameters: a RS resource Set for Set A; a RS resource Set for Set B; and/or a ReportQuantity. The WTRU may activate one or more CSI reporting configurations of the multiple CSI reporting configurations. For example, periodic CSI reporting configurations may be activated after the configuration (e.g., after RRCReconfigurationComplete). Semi-persistent CSI reporting configurations may be activated via DCI and/or MAC CE. Aperiodic CSI reporting may be triggered via DCI.

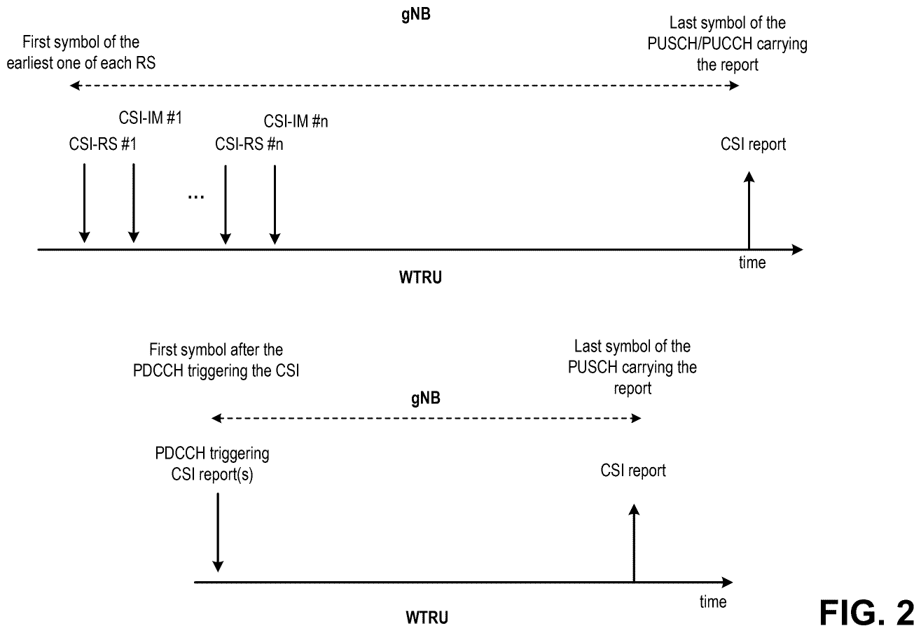

The WTRU may determine one or more CPU types (e.g., OCPU and/or O′CPU) and/or occupation timing based on the activated one or more CSI report configurations and/or corresponding CPU types. If an activated CSI reporting is a normal CSI reporting, the WTRU may determine one or more of the following for CPU occupation: value for OCPU (e.g., value O₀ for O_{CPU}). The WTRU may also determine the duration for CPU occupation. For periodic/semi-persistent CSI, from the first symbol of the earliest of each transmission occasion of periodic or semi-persistent CSI-reference signal (RS)/synchronization signal block (SSB) resource for channel measurement until the last symbol of the configured physical uplink share channel (PUSCH) and/or physical uplink control channel (PUCCH) carrying the report. For an initial semi-persistent CSI report on PUSCH, the duration may last from the first symbol after the physical downlink control channel (PDCCH) triggering the CSI report until the last symbol of the scheduled PUSCH carrying the report. FIG. 2 depicts a CPU for normal CSI and BM-Case 1. As seen in FIG. 2, for aperiodic CSI report, the duration may last from the first symbol after the PDCCH triggering the CSI report until the last symbol of the scheduled PUSCH carrying the report.

If an activated CSI reporting is a first type of AI/ML CSI reporting (e.g., BM Case 1), the WTRU may determine one or more of the following for CPU occupation: value O_{CPU} for N_{CPU} and/or value O′_{CPU} for N′_{CPU} (e.g., value O₁ as O_{CPU} and O₁′ as O′_{CPU}). The WTRU may also determine the duration for CPU occupation (normal CPU occupation). For N_{CPU} and/or O_{CPU}, specifically, for periodic/semi-persistent CSI, the duration may be from the first symbol of the earliest one of each transmission occasion of periodic or semi-persistent CSI-RS/SSB resource for channel measurement until the last symbol of the configured PUSCH and/or PUCCH carrying the report. For an initial semi-persistent CSI report on PUSCH, the duration may be from the first symbol after the PDCCH triggering the CSI report until the last symbol of the scheduled PUSCH carrying the report. For aperiodic CSI report, the duration may be from the first symbol after the PDCCH triggering the CSI report until the last symbol of the scheduled PUSCH carrying the report. For N′_{CPU} and O′_{CPU}, specifically for CSI reporting, the duration may be from before T3 time duration from the first symbol of the configured and/or scheduled PUSCH and/or PUCCH carrying the report until the last symbol of the configured/scheduled PUCCH and/or PUSCH carrying the report.

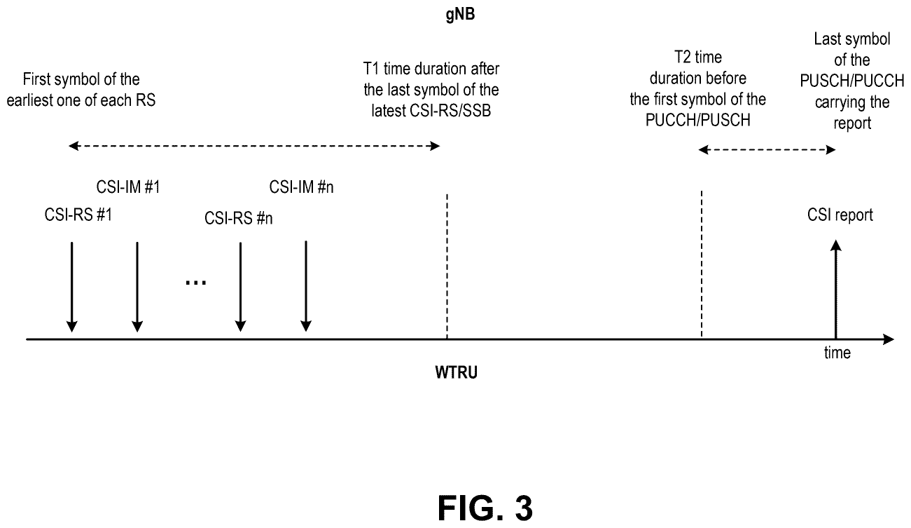

If an activated CSI reporting is a second type of AI/ML CSI reporting (e.g., BM Case 2), then the WTRU may determine one or more of the following for CPU occupation: values for O_{CPU} and/or O′_{CPU} (e.g., value O₂ as O_{CPU} and/or O₂′ as O′_{CPU}). The WTRU may also determine the duration for CPU occupation. For N_{CPU} and/or O_{CPU} the CPU calculation and/or occupation may be only for limited time duration. FIG. 3 depicts CPU occupation for BM-Case 2. As seen in FIG. 3, for RS measurement, the duration may be from the from the first symbol of the earliest one of each transmission occasion of CSI-RS/SSB resource for channel measurement and/or T1 time duration after the last symbol of the latest one of each CSI-RS/SSB for channel measurement. For CSI reporting, from before T2 time duration from the first symbol of the configured and/or scheduled PUSCH and/or PUCCH carrying the report until the last symbol of the configured and/or scheduled PUCCH and/or PUSCH carrying the report.

For CSI reporting, from before T4 time duration from the first symbol of the configured and/or scheduled PUSCH and/or PUCCH carrying the report until the last symbol of the configured and/or scheduled PUCCH and/or PUSCH carrying the report.

For periodic and/or semi-persistent CSI, the duration may be from the first symbol of the earliest one of each transmission occasion of periodic or semi-persistent CSI-RS/SSB resource for channel measurement until the last symbol of the configured PUSCH and/or PUCCH carrying the report.

For an initial semi-persistent CSI report on PUSCH, the duration may be from the first symbol after the PDCCH triggering the CSI report until the last symbol of the scheduled PUSCH carrying the report.

For aperiodic CSI report, the duration may be from the first symbol after the PDCCH triggering the CSI report until the last symbol of the scheduled PUSCH carrying the report.

The WTRU may apply the determined CPU types and/or the values. The WTRU may update the requested CSI reports beyond CPU capabilities with lowest priority. For normal CSI, the WTRU may update the requested CSI reports when sum of Ns is less than N_{CPU}. For AI/ML CSI, the WTRU may update the requested CSI reports when sum of O_{CPU}s is less than NCPU and/or the sum of O′_{CPUs} is less than N′_{CPU}. The WTRU may not add determined O_{CPU} values for AI/ML CSI when O′_{CPU} is beyond WTRU's capability. The WTRU may not add determined O′_{CPU} values for AI/ML CSI when O_{CPU} is beyond WTRU's capability.

As a benefit, the proposed solution may enable the WTRU to limit CPU occupation from AI/ML BM reporting (especially for BM-Case 2) and/or allowing other legacy CSI processing.

Hereinafter, ‘a’ and/or ‘an’ and similar phrases may be interpreted as ‘one or more’ and ‘at least one’. Similarly, any term which ends with the suffix ‘(s)’ may be interpreted as ‘one or more’ and ‘at least one’. The term ‘may’ may be interpreted as ‘may, for example’.

Artificial intelligence may be broadly defined as the behavior exhibited by machines. Such behavior may for example, mimic cognitive functions to sense, reason, adapt, and/or act.

Machine learning (ML) may refer to type of algorithms that solve a problem based on learning through experience (data), without explicitly being programmed (configuring set of rules). Machine learning may be considered as a subset of artificial intelligence (AI). Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing a sequence of actions in an environment to maximize the cumulative reward. It may be possible to apply machine learning algorithms using a combination and/or interpolation of the above-mentioned approaches. For example, semi-supervised learning approach may use a combination of a small amount of labeled data with a large amount of unlabeled data during training. In this regard semi-supervised learning may fall between unsupervised learning (e.g., with no labeled training data) and/or supervised learning (e.g., with only labeled training data).

Deep learning may refer to class of machine learning algorithms that employ artificial neural networks, specifically deep neural networks (DNNs), which were loosely inspired from biological systems. The DNNs are a special class of machine learning models inspired by human brain. In DNNs, an input may be linearly transformed and/or pass-through a non-linear activation function multiple times. DNNs may typically consist of multiple layers where each layer consists of linear transformation and/or a given non-linear activation function. The DNNs may be trained using the training data via back-propagation algorithm. Recently, DNNs may have shown state-of-the-art performance in variety of domains, e.g., speech, vision, natural language, etc, and/or for various machine learning settings supervised, un-supervised, and/or semi-supervised. The term AI/ML based methods and/or processing may refer to realization of behaviors and/or conformance to requirements by learning based on data, without explicit configuration of sequence of steps of actions. Such methods may enable learning complex behaviors which may be difficult to specify and/or implement when using legacy methods.

A WTRU may transmit and/or receive a physical channel and/or reference signal according to at least one spatial domain filter. The term “beam” may refer to a spatial domain filter.

The WTRU may transmit a physical channel and/or signal using the same spatial domain filter as the spatial domain filter used for receiving an RS (such as, e.g., CSI-RS) or a synchronization signal (SS) block. The WTRU transmission may be referred to as “target”, and the received RS and/or SS block may be referred to as “reference” or “source”. In such case, the WTRU may transmit the target physical channel and/or signal according to a spatial relation with a reference to such RS and/or SS block.

The WTRU may transmit a first physical channel or signal according to the same spatial domain filter as the spatial domain filter used for transmitting a second physical channel or signal. The first and/or second transmissions may be referred to as “target” and “reference” (or “source”), respectively. In such case, the WTRU may transmit the first (target) physical channel or signal according to a spatial relation with a reference to the second (reference) physical channel and/or signal.

A spatial relation may be implicit, configured by radio resource control (RRC) or signaled by medium access control (MAC) control element (CE) or downlink control information (DCI). A WTRU may implicitly transmit PUSCH and/or demodulation reference signals (DM-RS) of PUSCH according to the same spatial domain filter as a sounding reference signal (SRS) indicated by an SRS resource indicator (SRI) indicated in DCI or configured by RRC. A RRC may configure a spatial relation for an SRI and/or signaled by MAC CE for a PUCCH. Such spatial relation may also be referred to as a “beam indication”.

The WTRU may receive a first (target) downlink channel and/or signal according to the same spatial domain filter or spatial reception parameter as a second (reference) downlink channel and/or signal. Such association may exist between a physical channel such as PDCCH and/or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may indicated an association between a CSI-RS or SS block and a DM-RS by an index to a set of TCI states configured by RRC and/or signaled by MAC CE. Such indication may also be referred to as a “beam indication”.

Hereafter, a transmission and reception point (TRP) may be interchangeably used with one or more of transmission point (TP), reception point RP), radio remote head (RRH), distributed antenna (DA), base station (BS), a sector (e.g., of a BS), and/or a cell (e.g., a geographical cell area served by a BS), but still consistent with this invention. Hereafter, multi-TRP may be interchangeably used with one or more of MTRP, M-TRP, and multiple TRPs, but still consistent with this invention.

A WTRU may report a subset of CSI components. The CSI components may correspond to at least a CSI-RS resource indicator (CRI), a SSB resource indicator (SSBRI), an indication of a panel used for reception at the WTRU (such as a panel identity and/or group identity), measurements such as layer 1 (L1)-reference signal received power (RSRP), L1-signal-to-noise and interference ratio (SINR) taken from SSB or CSI-RS (e.g. cri-RSRP, cri-SINR, ssb-Index-RSRP, and/or ssb-Index-SINR), and/or other channel state information such as at least rank indicator (RI), channel quality indicator (CQI), precoding matrix indicator (PMI), layer Index (LI), and/or the like.

A WTRU may receive a synchronization signal/physical broadcast channel (SS/PBCH) block (SSB). The SSB may include a primary synchronization signal (PSS), a secondary synchronization signal (SSS), and/or a physical broadcast channel (PBCH). The WTRU may monitor, receive, and/or attempt to decode an SSB during initial access, initial synchronization, radio link monitoring (RLM), cell search, cell switching, etc.

A WTRU may measure and/or report the channel state information (CSI), wherein the CSI for each connection mode may include and/or be configured with one or more of following: CSI report configuration, including one or more of the following: CSI report quantity, e.g., CQI, RI, PMI, CRI, LI, etc.; CSI report type, e.g., aperiodic, semi persistent, periodic; CSI report codebook configuration, e.g., Type I, Type II, Type II port selection, etc.; and/or CSI report frequency.

The CSI for each connection mode may include and/or be configured with a CSI-RS resources, including one or more of the following CSI resource settings: non-zero power (NZP)-CSI-RS resource for channel measurement; NZP-CSI-RS resource for interference measurement; CSI-IM resource for interference measurement.

The CSI for each connection mode may include or be configured with NZP-CSI-RS Resources, including one or more of the following: NZP-CSI-RS resource identifier (ID); periodicity and/or offset; QCL Info and TCI-state; resource mapping, e.g., number of ports, density, code division multiplexing (CDM) type, etc.

A WTRU may indicate, determine, or be configured with one or more RSs. The WTRU may monitor, receive, and/or measure one or more parameters based on the respective RSs. For example, one or more of the following RS types described below may apply. The following parameters are non-limiting examples of the parameters that may be included in reference signal(s) measurements. One or more of these parameters may be included.

SS reference signal received power (SS-RSRP) may be measured based on the synchronization signals (e.g., DMRS in PBCH and/or SSS). SS-RSRP may be defined as the linear average over the power contribution of the resource elements (REs) that carry the respective SSs. In measuring the RSRP, power scaling for the reference signals may be required. In case SS-RSRP is used for L1-RSRP, the measurement may be accomplished based on CSI reference signals in addition to the SSs.

CSI-RSRP may be measured based on the linear average over the power contribution of the REs that carry the respective CSI-RS. The CSI-RSRP measurement may be configured within measurement resources for the configured CSI-RS occasions.

SS signal-to-noise and interference ratio (SS-SINR) may be measured based on the synchronization signals (e.g., DMRS in PBCH or SSS). SS-SINR may be defined as the linear average over the power contribution of the REs that carry the respective SS divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the REs that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and/or bandwidth. The power contribution may be received from different resources (e.g., co-channel serving and non-serving cells, adjacent channel interference, thermal noise, and so forth)

Cross-layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

Sounding reference signals RSRP (SRS-RSRP) may be measured based on the linear average over the power contribution of the REs that carry the respective SRS.

A CSI report configuration (e.g., CSI-ReportConfigs) may be associated with a single bandwidth part (BWP) (e.g., indicated by BWP-Id), wherein one or more of the following parameters are configured: CSI-RS resources and/or CSI-RS resource sets for channel and interference measurement; CSI-RS report configuration type including the periodic, semi-persistent, and/or aperiodic; CSI-RS transmission periodicity for periodic and/or semi-persistent CSI reports; CSI-RS transmission slot offset for periodic, semi-persistent and/or aperiodic CSI reports; CSI-RS transmission slot offset list for semi-persistent and aperiodic CSI reports; time restrictions for channel and/or interference measurements; report frequency band configuration (e.g., wideband/subband CQI, PMI, etc.); thresholds and/or modes of calculations for the reporting quantities (e.g., CQI, RSRP, SINR, LI, RI, etc.); codebook configuration; group based beam reporting; CQI table; subband size; non-PMI port indication; port index, etc.

A CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS resource: CSI-RS periodicity and/or slot offset for periodic and semi-persistent CSI-RS resources; CSI-RS resource mapping to define the number of CSI-RS ports, density, CDM-type, OFDM symbol, and/or subcarrier occupancy; he BWP to which the configured CSI-RS is allocated; and/or the reference to the TCI-State including the QCL source RS(s) and the corresponding QCL type(s).

A WTRU may be configured with one or more RS resource sets. The RS resource set configuration may include one or more of following: RS resource set ID; one or more RS resources for the RS resource set; repetition (e.g., on or off); aperiodic triggering offset (e.g., one of 0-6 slots and/or tracking reference signal (TRS) info (e.g., true or not).

A WTRU may be configured with one or more RS resources. The RS resource configuration may include one or more of following: RS resource ID; resource mapping (e.g., REs in a PRB); power control offset (e.g., one value of −8, . . . , 15); power control offset with SS (e.g., −3 dB, 0 dB, 3 dB, and/or 6 dB); scrambling ID, periodicity and/or offset, and/or QCL information (e.g., based on a TCI state).

A property of a grant or assignment may consist of at least one of the following: a frequency allocation; an aspect of time allocation, such as a duration; a priority; a modulation and/or a coding scheme; a transport block size; a number of spatial layers; a number of transports blocks; a TCI state, CRI and/or SRI a number of repetitions; whether the repetition scheme is Type A or Type B; whether the grant is a configured grant type 1, type 2, and/or a dynamic grant; whether the assignment is a dynamic assignment or a semi-persistent scheduling (configured) assignment; a configured grant index or a semi-persistent assignment index; a periodicity of a configured grant and/or assignment; a channel access priority class (CAPC); any parameter provided in a DCI, by MAC, by LTE positioning protocol (LPP), or by RRC for the scheduling the grant and/or assignment.

An indication by DCI may consist of at least one of the following: an explicit indication by a DCI field or by radio network temporary identifier (RNTI) used to mask a cyclic redundancy check (CRC) of the PDCCH; an implicit indication by a property such as DCI format, DCI size, CORESET and/or search space, aggregation level, first resource element of the received DCI (e.g., index of first control channel element), where the mapping between the property and the value may be signaled by RRC and/or MAC.

The WTRU may indicate the number of supported simultaneous CSI calculations N_{CPU} with parameter simultaneousCSI-ReportsPerCC in a component carrier, and/or simultaneousCSI-ReportsAIICC across all component carriers. If a WTRU supports N_{CPU} simultaneous CSI calculations, it is said to have N_{CPU} CSI processing units (CPUs) for processing CSI reports. If L CPUs may be occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the WTRU may not be required to update the N−M requested CSI reports with lowest priority, where 0≤M≤N is the largest value such that

$${\sum }_{n = 0}^{M - 1} {O}_{CPU}^{( n )} \leq {N}_{CPU} - L$$

For a CSI report with CSI-ReportConfig with higher layer parameter reportQuantity not set to ‘none’, the CPU(s) may be occupied for a number of OFDM symbols as follows: a periodic and/or semi-persistent CSI report (excluding an initial semi-persistent CSI report on PUSCH after the PDCCH triggering the report and/or a semi-persistent CSI report on PUSCH configured with the higher layer parameter codebookType set to ‘typeII-Doppler-r18’ or ‘typeII-Doppler-PortSelection-r18’) may occupy CPU(s) from the first symbol of the earliest one of each CSI-RS/CSI-IM/SSB resources. Each CSI-RS/CSI-IM resource associated with all configured sub-configurations for periodic CSI report corresponding to a CSI-ReportConfig may contain a list of sub-configurations provided by csi-ReportSubConfigList, and/or each CSI-RS/CSI-IM resource associated with all triggered sub-configurations for semi-persistent CSI report corresponding to a CSI-ReportConfig may contain a list of sub-configurations provided by csi-ReportSubConfigList. For channel and/or interference measurement, respective latest CSI-RS/CSI-IM/SSB occasion may be no later than the corresponding CSI reference resource, until the last symbol of the configured PUSCH and/or PUCCH carrying the report.

An aperiodic CSI report may occupy CPU(s) from the first symbol after the PDCCH triggering the CSI report until the last symbol of the scheduled PUSCH carrying the report. When the PDCCH reception may include two PDCCH candidates from two respective search space sets for the purpose of determining the CPU occupation duration, the PDCCH candidate that ends later in time is used.

An initial semi-persistent CSI report on PUSCH after the PDCCH trigger may occupy CPU(s) from the first symbol after the PDCCH until the last symbol of the scheduled PUSCH carrying the report. When the PDCCH reception may include two PDCCH candidates from two respective search space sets for the purpose of determining the CPU occupation duration, the PDCCH candidate that ends later in time is used.

A semi-persistent CSI report on PUSCH configured with the higher layer parameter codebookType set to ‘typeII-Doppler-r18’ or ‘typeII-Doppler-PortSelection-r18’ occupies CPU(s) from the first symbol of K_{P}-th latest consecutive periodic/semi-persistent CSI-RS occasions no later than CSI reference resource, until the last symbol of the PUSCH carrying the report, where the value of K_{P}∈{1,2,4} may be indicated by WTRU capability.

For a CSI report with CSI-ReportConfig with higher layer parameter reportQuantity set to ‘none’ and CSI-RS-ResourceSet with higher layer parameter trs-Info not configured, the CPU(s) may be occupied for a number of OFDM symbols as follows: a semi-persistent CSI report (excluding an initial semi-persistent CSI report on PUSCH after the PDCCH triggering the report) occupies CPU(s) from the first symbol of the earliest one of each transmission occasion of periodic and/or semi-persistent CSI-RS/SSB resource for channel measurement for L1-RSRP computation, until

$${Z}_{3}^{′}$$

symbols after the last symbol of the latest one of the CSI-RS/SSB resource for channel measurement for L1-RSRP computation in each transmission occasion.

An aperiodic CSI report may occupy CPU(s) from the first symbol after the PDCCH triggering the CSI report until the last symbol between Z₃ symbols after the first symbol after the PDCCH triggering the CSI report and/or

$${Z}_{3}^{′}$$

symbols after the last symbol of the latest one of each CSI-RS/SSB resource for channel measurement for L1-RSRP computation.

TABLE 1
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X5 + KB3) | X5 |
| 6 | 776 | 680 | 1216 | 1120 | min(776, X6 + KB4) | X6 |

RS may be interchangeably used with one or more of RS resource, RS resource set, RS port and/or RS port group. RS may be interchangeably used with one or more of SSB, CSI-RS, SRS, DM-RS, TRS, PRS, and PTRS, but still consistent herein. Hereafter, a RS may be interchangeably used with one or more of following: SRS, CSI-RS, DM-RS, phase tracking reference signal (PT-RS), SSB, but still consistent with the invention. The term “channel” may be interchangeably used with one or more of following: PDCCH, PDSCH, PUCCH, PUSCH, random access channel preamble (PRACH), etc.

A key performance indicator (KPI) may refer to, but not limited to, one or more of the following: signal quality (e.g., L1-RSRP, SINR, CQI, RSSI, RSRQ); prediction performance (e.g., Percentage of the Top-1 genie-aided (e.g., best) beam is one of the Top-K predicted beams); link quality (e.g., throughput, block error rate (BLER)); data distribution (e.g., mean and/or variance of measured and/or predicted beam measurements); and/or RSRP (e.g., L1-RSRP) difference (e.g., the difference between measured and predicted RSRP of a beam).

A signal, channel, and message (e.g., as in DL and/or UL signal, channel, and/or a message) may be used interchangeably. A RS resource set may be interchangeably used with a RS resource and a beam group, but still consistent with this invention. Beam reporting may be interchangeably used with CSI measurement, CSI reporting, and/or beam measurement. The proposed solutions for beam resources prediction may be used for beam resources belonging to a single and/or multiple cells as well as single and/or multiple TRPs, and still consistent with this invention.

CSI reporting may be interchangeably used with CSI measurement, beam reporting and beam measurement. A RS resource set may be interchangeably used with a beam group. A Set B may be interchangeably used with a set of RS resource sets, beams, beam-pairs, beam RS resources, RS resources and a beam pattern. Set B may be interchangeably used with measurement RS resources, measurement RS resource set, measurement beam resources, measurement beam resource set, measurement beam pattern, measurement TCI states, and/or measurement TCI state group, etc. A Set A may be interchangeably used with a set of—RS resource sets, beams, beam-pairs, beam RS resources, RS resources, and/or a beam pattern. Beam prediction accuracy may be interchangeably used with prediction accuracy.

The WTRU may communicate with the network about the WTRU's AI/ML capability (e.g., where the WTRU can indicate to the network the supported AIML models/functions, confidence level of predictions, time horizon of predictions (how far along in the future are the prediction being made), etc.) The WTRU may support several AI/ML models for a certain functionality (e.g., with different prediction time horizons, prediction confidence levels, processing requirements, trained under/for operation in different frequencies, cells, location, times of day, etc.)

A given AIML model can operate in different modes (e.g., with different levels of prediction confidence levels at different prediction time horizons, at different locations, frequencies, WTRU mobility pattern and/or speed, etc.)

The AI/ML models can be available at the WTRU already trained, or the WTRU may be provided with an untrained AI/ML model and/or perform the training by itself. The AI/ML model may be available at the WTRU already trained. The WTRU may be enabled and/or configured to perform further training (e.g., for different conditions such as frequencies, cells, location, times of day, for the same conditions as the initial training but for increasing the level of confidence or/and the prediction time horizon, for different WTRU speeds, etc.)

The A/IML model is available at the WTRU but not trained at all or only trained for certain WTRU and/or network conditions, and WTRU may be configured to train the model (e.g., for the conditions that it is not trained for).

The WTRU may require some configurations/inputs that it needs for performing the inference using an AI/ML model. For beam prediction, the WTRU may be configured with a certain number of beams to measure other beams (e.g., set A and/or set B configuration referred to above). The WTRU may communicate the required configuration and/or input as part of the capability information. The required configuration and/or input may be communicated to the network after capability request (e.g., based on explicit network request if the WTRU gets configured to do AI/ML based BM operations and has determined that it lacks the required configuration and/or input, etc.).

A given AI/ML functionality may be associated with a set of KPI and/or metrics. For example, this could be prediction accuracy, average or mean square difference between measured and predicted values etc. (e.g., for the beam prediction, these could be the beam prediction accuracy or/and confidence level, L1 RSRP difference between the measured and predicted beam signal levels, etc.) A WTRU may have one or more AIML models for a given functionality, and each may have performance levels that meet different KPI thresholds. A WTRU may have two models: one may have an accuracy level of 90% and another may have an accuracy level of 95%, etc. The WTRU may inform the network during its capability reporting and/or after the capability reporting.

A given AI/ML model may train under certain WTRU and/or network side additional conditions. For example, a WTRU side condition may be the speed of the WTRU. Network side additional conditions may relate to some network configurations and/or settings that the WTRU may impact the performance of the model. An AI/ML beam management model may perform differently if the model is trained when the network was using a certain antenna pattern, beam pattern, power levels, etc. Also, aspects related to network load may impact the model performance.

Since the WTRU does not need to know all the details of the network side additional conditions (and network may also not want to expose some of these implementation), the network may hide these details by signaling to the WTRU one or more associated ID(s). When data is collected for training a model, tagging may be performed to indicate under which additional network side conditions the model is being trained. When a WTRU performs an AI/ML operation, the WTRU may check the consistency between the conditions under which the AI/ML model is trained on and/or current conditions (e.g., current WTRU conditions, and/or current associated ID(s) signaled by the network indicating current network conditions/settings, etc.)

In the descriptions below, reference to the full and/or partial validity and/or applicability of an associated ID may indicate whether the WTRU has an AI/ML model and/or functionality that is valid and/or applicable for the concerned associated ID. For example, a network may signal the same associated ID(s) to multiple WTRUs. A first WTRU may determine to be fully applicable, a second WTRU may determine to be partially applicable, and/or a third WTRU may determine to be not applicable at all.

The term life cycle management (LCM) may describe the overall management aspects of AI/ML models, such as: model training; functionality and/or model identification; model delivery and/or transfer; model inference operation; functionality and/or model selection; activation; deactivation; switching; and/or fallback operation, including a decision by the network (either network initiated or WTRU-initiated and requested to the network), decision by the WTRU (event-triggered as configured by the network, the WTRU's decision reported to the network, and/or WTRU-autonomous either with WTRU's decision reported to the network or without it); functionality and/or model monitoring; model update; WTRU capability; data collection (for model training, for monitoring, for inference, etc.); LCM can be functionality-based LCM or model-ID based LCM.

In functionality-based LCM, a network may indicate activation, deactivation, fallback, and/or switching of AI/ML functionality via 3GPP signaling (e.g., RRC, MAC-CE, DCI). Models may not be identified at the network, and/or the WTRU may perform model-level LCM. The WTRU may have one AI/ML model for the functionality, or the WTRU may have multiple AI/ML models for the functionality.

In model-ID-based LCM, models may be identified at the network, and the network and/or WTRU may activate, deactivate, select, and/or switch individual AI/ML models via model ID.

In the functionality based LCM, the WTRU may choose the AI/ML model to use for a certain functionality (e.g., network decides for which functionalities the WTRU can use AI/ML based operation, and the WTRU chooses the AI/ML model to use).

In the model-ID based LCM, the network may explicitly control which particular model is used for a given AI/ML functionality. For example, the WTRU may provide details of AI/ML models and/or their capabilities. The network may determine which model to activate for a particular functionality.

The solution descriptions below are applicable to both model-ID based and/or functionality-based LCM. Solutions relate to how the WTRU may determine whether it has a model applicable for the indicated associated ID(s). For example, in the case of functionality-based LCM, the WTRU may be configured and/or requested to determine if a given functionality is valid and/or applicable. The WTRU may perform the determination among all the models it has for a given functionality. The WTRU may consider the functionality applicable if at least one of the models is applicable. In the case of model-ID based LCM, the WTRU may be configured and/or requested by the network to determine whether a particular model is applicable or not.

The activation of an associated ID may refer that the network is configuring the WTRU with an associated ID to use, consider, and/or further indicate to the WTRU to determine if the WTRU has an AI/ML model and/or functionality applicable for that associated ID (and/or sub-associated IDs). Whether an associated ID may be applicable refers to the WTRU having an AI/ML functionality and/or model applicable for the concerned associated ID (and/or related sub-associated IDs).

Regarding functionality based LCM, the WTRU may consider the associated ID applicable (or partially applicable) if at least one AI/ML model for that functionality may meet the applicability (or partial applicability) criteria.

In the case of model-ID based LCM, the WTRU may determine the associated IDs' applicability (or partial applicability) for each AI/ML model for that functionality. Alternatively, the WTRU may be explicitly configured to determine applicability for a certain subset of the AI/ML models. The WTRU may report the non-applicability, partial applicability, or (full) applicability for all the models (or the configured subset of models). The WTRU may send the list of the applicable models, the list of the non-applicable models, the list of the partial applicable models, etc., and/or a bitmap indicating which models are applicable or non-applicable, where the order in the bitmap is, e.g., based on some model ID soring order agreed upon the WTRU and the network, etc.,

An associated ID may be unique for a certain functionality. An associated IS may be shared among multiple functionalities. For the case where an associated ID can be applicable for more than one functionality, the WTRU may determine applicability for the associated ID for each of the concerned functionality according to any of the solutions below. The WTRU may further indicate to the network to which of the functionalities the associated ID is applicable or not (e.g., the list of the applicable functionalities, the list of non-applicable functionalities, the list of partially applicable functionalities, and/or using a bit map structure, and/or similar to the one described above for the model ID based LCM, etc.

The WTRU may immediately start applying the AI/ML model/functionality if the WTRU determines to be applicable for the configured and/or indicated associated ID. In other solutions, the WTRU may indicate the applicability to the network and/or wait for an indication from the network to further activate the AI/ML functionality and/or model.

The WTRU may be configured with a time duration. If the WTRU does not receive an indication from the network not to activate the concerned functionality and/or model (e.g., within the time duration after the reception of the associated ID activation command, within the time duration after the sending of the applicability, and/or partial applicability indication, within the time duration after the reception of a lower layer ACK indicating the reception of the application indication by the network, etc.), the WTRU may activate the concerned functionality and/or model.

AI/ML functionalities mentioned in the descriptions below, such as beam management, may not be limiting to the proposed solutions. For example, the proposed solutions may be used for any AI/ML functionality, as long as the functionality may be used in a multi-TRP scenario and/or the functionality is impacted depending on whether the WTRU may operate in a single TRP and/or multi-TRP scenario.

The proposed solutions are also equally valid to any other form of functionality that uses prediction that is not based on AIML (e.g. time series forecasting, interpolation methods, etc.).

All the solutions described herein are agnostic to the kind of AI/ML model/technique used by the WTRU (e.g., the algorithm used, the mechanism such as neural network or what kind of neural network, e.g., depth and/or parameters and/or weights of the network, etc.) the origins of the model (e.g., WTRU vendor, operator, and/or network vendor, etc.) and/or how and/or where the training of the model is done (e.g., the input data used for the training, where the training is performed, if the training is performed offline and/or online, etc.) However, the model may be trained based on historical observation of one or more WTRU's actual measurements in different WTRU and/or network conditions (e.g., during certain time durations of the day, during certain days of the week, at different locations, different WTRU mobility patterns and/or speeds, under different network conditions visible to the WTRU such as frequency and/or bandwidth, etc., under different network configurations.) Different network conditions may be visible to the WTRU just as a network configuration index that the network may provide at the time of training or data collection for the training, etc.

The concept of sub-associated IDs described herein may not be limited to just one level of grouping. As associated ID may contain a group of sub-associated IDs. For example, solutions may be envisioned where a sub-associated ID may have related sub-associated IDs of its own (e.g., several layers of grouping of associated IDs). Also, a sub-associated ID may belong to more than one associated ID. The terms “functionality” and “procedure” may be used interchangeably.

A solution describes herein may be a determination of a type and/or occupation duration of CPU for AI/ML BM reporting. A WTRU may receive one or more CSI reporting configurations, wherein each CSI reporting configuration may include at least one or more of the following parameters: one or more CSI resource configurations, wherein a first CSI resource configuration may be associated with a RS resource set for Set A and/or a second CSI resource configuration may be associated with a RS resource set for Set B; CSI report quantity, (e.g., CQI, RI, PMI, CRI, LI, etc.); CSI report type (e.g., aperiodic, semi persistent, and/or periodic); and/or CSI report codebook configuration, (e.g., Type I, Type II, Type II port selection, etc.); and/or CSI report frequency.

The WTRU may activate one or more CSI reporting configurations of the one or more CSI reporting configurations. The activation may be based on gNB indication/activation. For example, one or more of the following may be used: the WTRU may activate one or more periodic CSI reporting configurations after receiving the configuration (e.g., after receiving RRCReconfigurationComplete). The WTRU may activate one or more semi-persistent CSI reporting configurations after receiving gNB activation message (e.g., via DCI and/or MAC CE). The WTRU may activate one or more aperiodic CSI reporting configurations after receiving a trigger (e.g., via DCI).

The WTRU may determine one or more CPU types for each activated CSI report configuration. The determination may be based on one or more of the following configurations: CSI report quantity: a first type of CPU (e.g., O_{CPU}/N_{CPU} for normal CPU type) may be used for a first CSI report quantity (e.g., normal CSI/beam reporting including CRI/SSBRI/RI/PMI/CQI). A second type of CPU (e.g., O_{CPU}/N_{CPU} for normal CPU type and/or O′_{CPU}/N′_{CPU} for AI/ML CPU type) may be used for a second CSI report quantity (e.g., AI/ML CSI/beam reporting including beam indication based on Set A and/or measurement of Set B in spatial domain, beam prediction in time domain, CSI compression, CSI prediction, and/or positioning prediction, etc.).

The determination may be based on CSI report config type: a first type of CPU (e.g., O_{CPU}/N_{CPU} for normal CPU type) may be used for a first CSI report config type (e.g., non-AI/ML CSI configuration). A second type of CPU (e.g., O_{CPU}/N_{CPU} for normal CPU type and/or O′_{CPU}/N′_{CPU} for AI/ML CPU type) may be used for a second CSI report config type (e.g., AI/ML CSI configuration).

The determination may be based on CSI report type: a first type of CPU (e.g., O_{CPU}/N_{CPU} for normal CPU type) may be used for a first CSI report type (e.g., periodic and/or semi-persistent CSI). A second type of CPU (e.g., O_{CPU}/N_{CPU} for normal CPU type and/or O′_{CPU}/N′_{CPU} for AI/ML CPU type) may be used for a second CSI report type (e.g., aperiodic CSI).

The determination may be based on RS transmission type: a first type of CPU (e.g., O_{CPU}/N_{CPU} for normal CPU type) may be used for a CSI report config associated with a first RS transmission type (e.g., periodic and/or semi-persistent CSI-RS). A second type of CPU (e.g., O_{CPU}/N_{CPU} for normal CPU type and/or O′_{CPU}/N′_{CPU} for AI/ML CPU type) may be used for a second CSI report configuration associated with a second RS transmission type (e.g., aperiodic CSI-RS).

The determination may be based on a number of RS resources: a first type of CPU (e.g., O_{CPU}/N_{CPU} for normal CPU type) may be used for a CSI report config associated with a first number of RS resources smaller than (or equal to) X1. A second type of CPU (e.g., O_{CPU}/N_{CPU} for normal CPU type and/or O′_{CPU}/N′_{CPU} for AI/ML CPU type) may be used for a second CSI report config associated with a second number of RS resources larger than X1.

The determination may be based on a number of RS ports: a first type of CPU (e.g., O_{CPU}/N_{CPU} for normal CPU type) may be used for a CSI report config associated with a first number RS ports smaller than (or equal to) X2. A second type of CPU (e.g., O_{CPU}/N_{CPU} for normal CPU type and/or O′_{CPU}/N′_{CPU} for AI/ML CPU type) may be used for a second CSI report configuration associated with a second number of RS ports larger than X2. The number of RS ports may be at least one of average, median, and/or maximum and minimum of RS ports associated with each CSI report config. For SSB, a fixed number of RS ports may be predefined (e.g., one or two).

The WTRU may determine one or more CPU values for each activated CSI report configuration and/or each CPU type (e.g., a first CPU type and/or a second CPU type). The WTRU may determine one or more CPU values for O_{CPU}/N_{CPU}. For example, one or more of the following values may be used: O_{CPU} may be 0 if reportQuantity=none and/or CSI-RS resource set with higher layer parameter trs-Info configured. O_{CPU} may be 1 if reportQuantity=one or more of ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured). O_{CPU} may be (Y+1) X, if reportQuantity=‘tdcp’ with number of delays Y configured. Where the value of X={1, 2} is reported by WTRU capability.

When reportQuantity=cri-RI-PMI-CQI, O_{CPU} may be NCPU=if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report. The codebookType may be set to ‘typeI-SinglePanel’ or where reportQuantity is set to ‘cri-RI-CQI’. O_{CPU} may be XN+M, if codebookType=typeI-SinglePanel and/or the corresponding CSI-RS resource set for channel measurement may be configured with two resource groups and/or N resource pairs, where X is the number of CPUs occupied by a pair of CMRs.

O_{CPU} may be O₁ (e.g., 1) if reportQuantity indicates CSI report quantity for beam prediction in spatial domain beam prediction (e.g., measurement based on a resource set of Set B and/or CRI/SSBRI indication (e.g. up to 4) based on a resource set of Set A). O_{CPU} may be O₂ (e.g., 1) if reportQuantity indicates CSI report quantity for beam prediction (e.g., temporal domain beam prediction (e.g., measurement based on a resource set of Set A and/or set B and/or reporting of CRI/SSBRI indication (e.g. up to 4 for each time instance) for multiple time instances based on a resource set of Set A and/or set B).

The WTRU may determine one or more CPU values for O′_{CPU}/N′_{CPU}. One or more of the following values may be used: O′_{CPU} may be O₁′ (e.g., 1) if reportQuantity indicates CSI report quantity for beam prediction in spatial domain beam prediction (e.g., measurement based on a resource set of Set B and CRI/SSBRI indication (e.g. up to 4) based on a resource set of Set A).

O′_{CPU} may be O₂′ (e.g., 1) if reportQuantity indicates CSI report quantity for beam prediction (e.g., temporal domain beam prediction (e.g., measurement based on a resource set of Set A and/or set B and/or reporting of CRI/SSBRI indication (e.g. up to 4 for each time instance) for multiple time instances based on a resource set of Set A and/or set B). O′_{CPU} may be 0 or may not be defined for other reportQuantity parameters. One or more CPU values of O′_{CPU}/N′_{CPU} for one or more of CSI report config, CSI report quantity, CSI report config type, each associated ID, and/or each inference configuration ID, etc. may be received and/or indicated. The WTRU may indicate the one or more CPU values to the gNB (e.g., via one or more of RRC, MAC CE, uplink control information (UCI), uplink assistance information (UAI), etc.). The WTRU may configure the one or more CPU values (e.g., via one or more of RRC, MAC CE, and/or DCI, etc.)

The WTRU may determine one or more CPU durations (e.g., CPU occupation types) for each activated CSI report configuration and/or each CPU type (e.g., a first CPU type or a second CPU type). The one or more CPU durations (e.g. occupation types) may be one or more of the following:

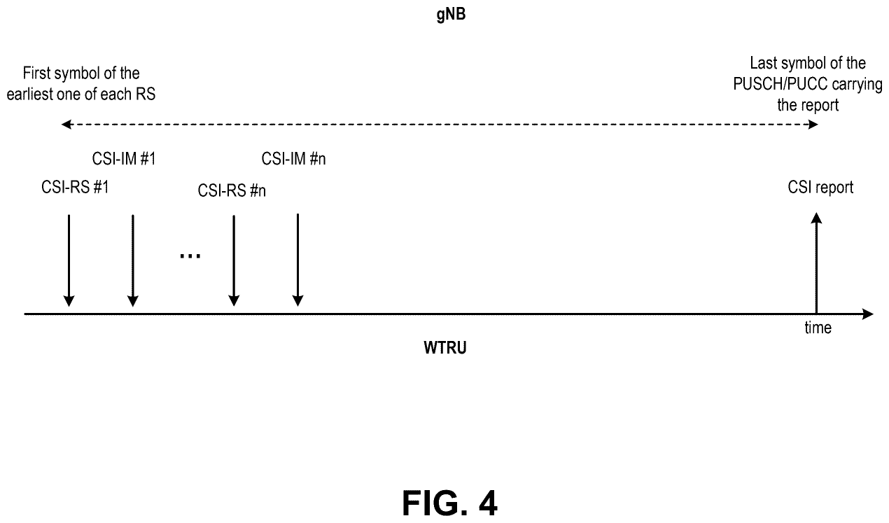

CPU occupation type 1: a CSI report config may occupy CPU(s) from RS measurement until corresponding CSI report. For example, and as seen in FIG. 4 which depicts CPU occupation type 1, a CSI report configuration may occupy CPU(s) from the first symbol of the earliest one of each CSI-RS/CSI-IM/SSB resource, or each CSI-RS/CSI-IM resource associated with all configured sub-configurations for periodic CSI report corresponding to a CSI-ReportConfig that contains a list of sub-configurations provided by csi-ReportSubConfigList. The CSI report configuration may occupy CPU(s) for each CSI-RS/CSI-IM resource associated with all triggered sub-configurations for semi-persistent CSI report corresponding to a CSI-ReportConfig that contains a list of sub-configurations provided by csi-ReportSubConfigList, for channel or interference measurement, respective latest CSI-RS/CSI-IM/SSB occasion no later than the corresponding CSI reference resource until the last symbol of the configured PUSCH and/or PUCCH carrying the report.

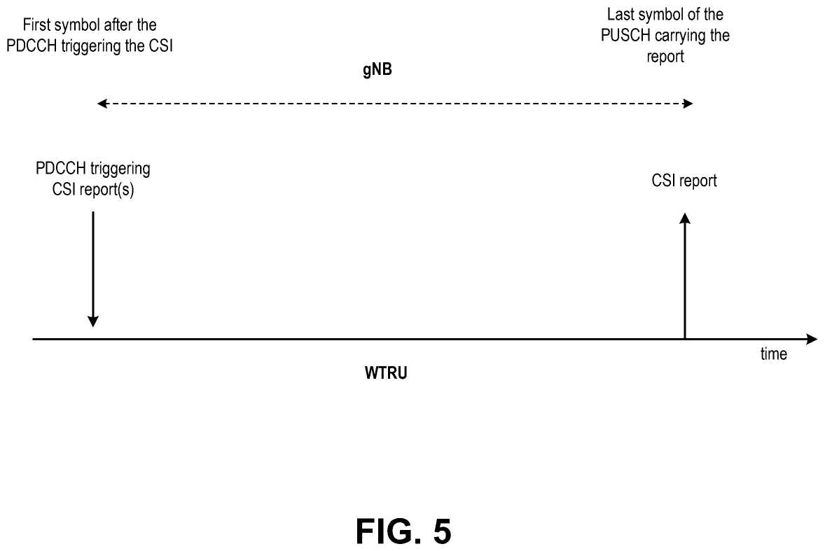

CPU occupation type 2: a CSI report configuration may occupy CPU(s) from activation and/or trigger of a CSI report (e.g., MAC CE and/or PDCCH) until a corresponding CSI report. For example, as seen in FIG. 5 which depicts CPU occupation type 2, a CSI report may occupy from the first symbol after the PDCCH triggering the CSI report until the last symbol of the scheduled PUSCH carrying the report.

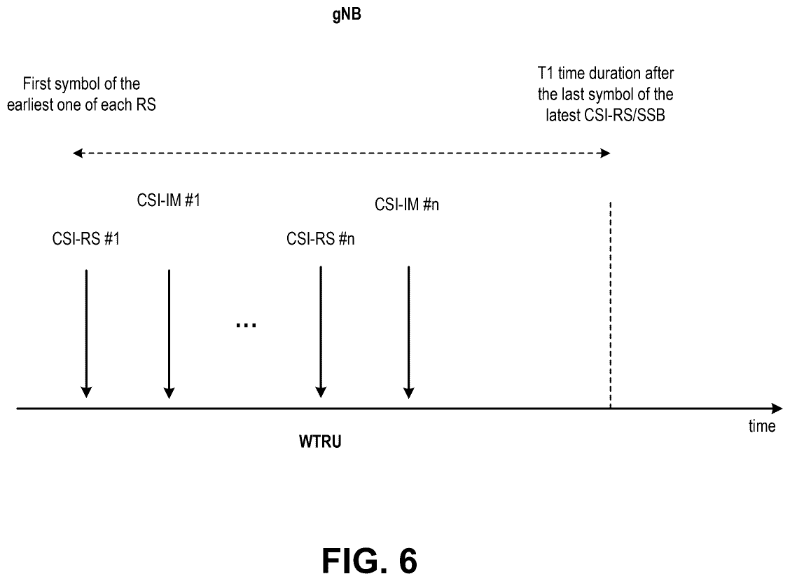

CPU occupation type 3: a CSI report configuration may occupy CPU(s) from RS measurement until end of RS measurement+T1 time duration (measured in, e.g., ms, ns, symbols, and/or slots, etc.). For example, as seen in FIG. 6, which depicts CPU occupation type 3, a CSI report configuration may occupy CPU(s) from the first symbol of the earliest one of each CSI-RS/CSI-IM/SSB resource, or each CSI-RS/CSI-IM resource associated with all configured sub-configurations for periodic CSI report corresponding to a CSI-ReportConfig that contains a list of sub-configurations provided by csi-ReportSubConfigList. A CSI report configuration may occupy each CSI-RS/CSI-IM resource associated with all triggered sub-configurations for semi-persistent CSI report corresponding to a CSI-ReportConfig that may contain a list of sub-configurations provided by csi-ReportSubConfigList, for channel or interference measurement, respective latest CSI-RS/CSI-IM/SSB occasion no later than the corresponding CSI reference resource, until last one of the CSI-RS/CSI-IM/SSB resource+T1. The value of T1 may depend on WTRU capability and/or subcarrier spacing (SCS), etc.

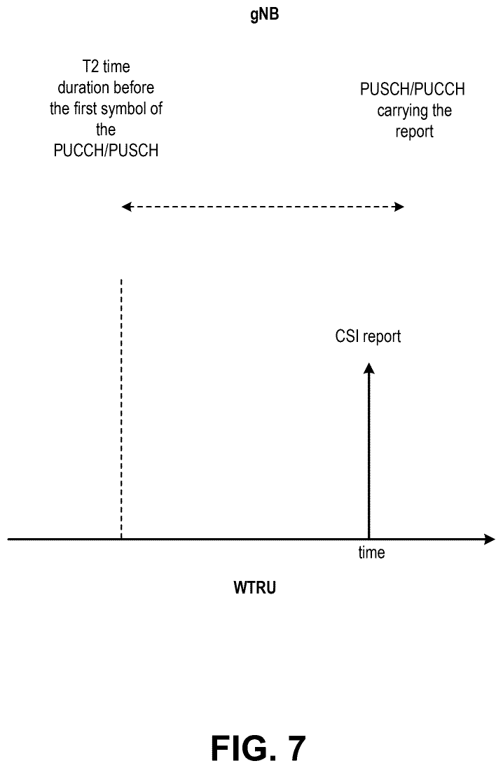

CPU occupation type 4: a CSI report configuration may occupy CPU(s) from T2 time before corresponding CSI report until corresponding CSI report. For example, as seen in FIG. 7, which depicts CPU occupation type 4, a CSI report may occupy from the first/last symbol the scheduled PUSCH and/or PUCCH−T2 until the last symbol of the scheduled/activated PUSCH and/or PUCCH carrying the report. The value of T2 may depend on WTRU capability and/or SCS, etc.

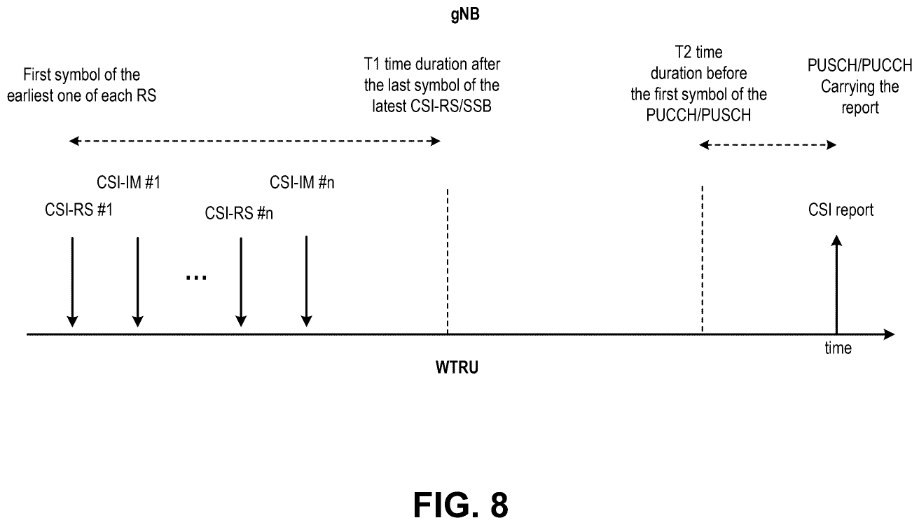

CPU occupation type 5: a CSI report configuration may occupy CPU(s) from RS measurement until end of RS measurement+T1 time duration (measured in, e.g., ms, ns, symbols, and/or slots, etc.) and from T2 time before corresponding CSI report until corresponding CSI report. For example, as seen in FIG. 8 which depicts CPU occupation type 5, a CSI report config may occupy CPU(s) from the first symbol of the earliest one of each CSI-RS/CSI-IM/SSB resource, or each CSI-RS/CSI-IM resource associated with all configured sub-configurations for periodic CSI report corresponding to a CSI-ReportConfig that contains a list of sub-configurations provided by csi-ReportSubConfigList. A CSI report configuration may occupy each CSI-RS/CSI-IM resource associated with all triggered sub-configurations for semi-persistent CSI report corresponding to a CSI-ReportConfig that contains a list of sub-configurations provided by csi-ReportSubConfigList, for channel or interference measurement, respective latest CSI-RS/CSI-IM/SSB occasion no later than the corresponding CSI reference resource, until last one of the CSI-RS/CSI-IM/SSB resource+T1 and from the first/last symbol the scheduled PUSCH and/or PUCCH−T2 until the last symbol of the scheduled and/or activated PUSCH and/or PUCCH carrying the report. The value of T1 and/or T2 may depend on WTRU capability and/or SCS, etc.

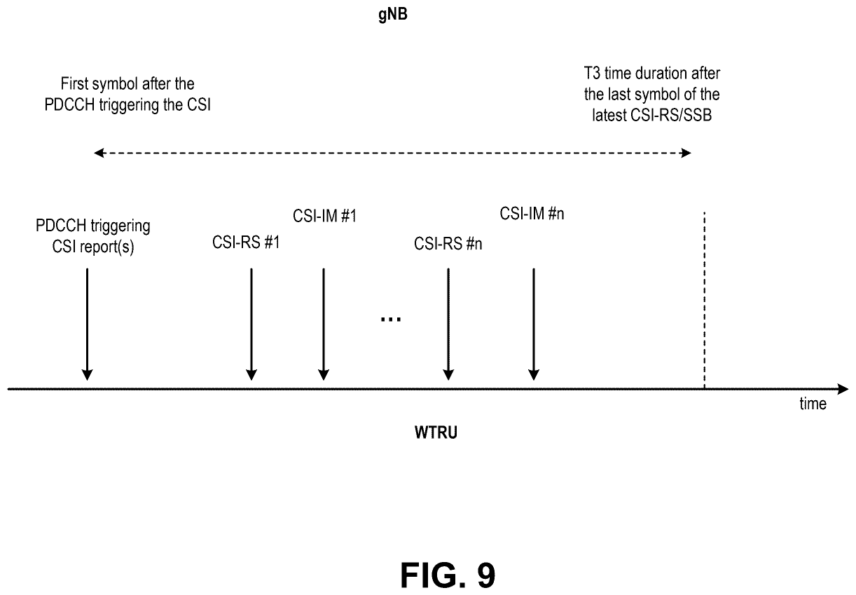

CPU occupation type 6: a CSI report config may occupy CPU(s) from activation and/or trigger of CSI report (e.g., MAC CE and/or PDCCH) until end of RS measurement+T3 time duration (measured in, e.g., ms, ns, symbols, and/or slots, etc.) For example, as seen in FIG. 9 which depicts CPU occupation type 6, a CSI report configuration may occupy CPU(s) from the first symbol after the PDCCH triggering the CSI report until the last one of the CSI-RS/CSI-IM/SSB resource+T3. The value of T3 may depend on WTRU capability and/or SCS, etc.

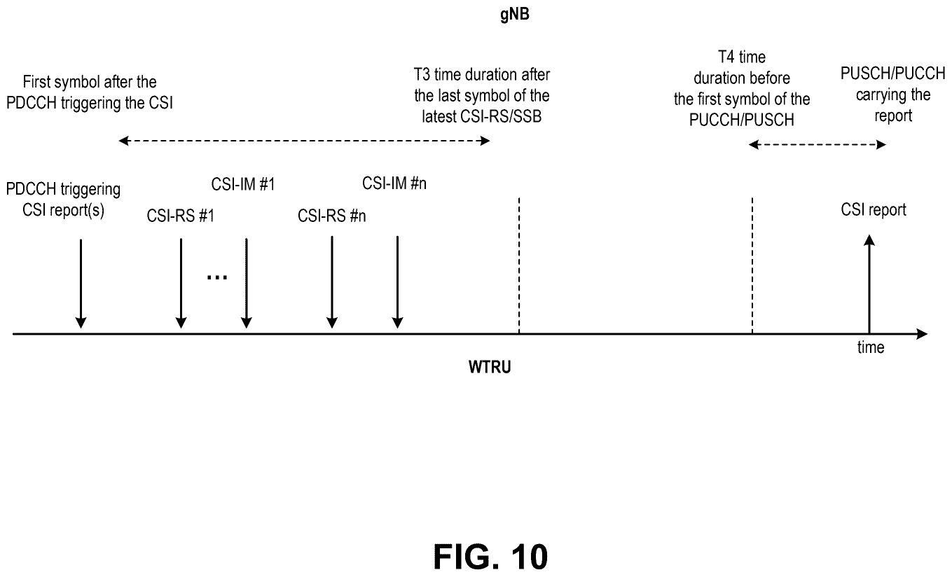

CPU occupation type 7: a CSI report config may occupy CPU(s) from activation and/or trigger of CSI report (e.g., MAC CE and/or PDCCH) until end of RS measurement+T3 time duration measured in, e.g., ms, ns, symbols, and/or slots, etc.) and from T4 time before corresponding CSI report until corresponding CSI report. For example, as seen in FIG. 10, which depicts CPE occupation type 7, a CSI report config may occupy CPU(s) from the first symbol after the PDCCH triggering the CSI report until the last one of the CSI-RS/CSI-IM/SSB resource+T3 and from the first/last symbol the scheduled PUSCH and/or PUCCH−T4 until the last symbol of the scheduled/activated PUSCH and/or PUCCH carrying the report. The value of T3 and/or T4 may depend on WTRU capability and/or SCS, etc.

The WTRU may determine one or more CPU occupation types for each CSI report config. For example, the determination may be based on one or more of the following:

CSI report quantity: a first CPU occupation type (e.g., CPU occupation type 1 and/or 2) may be used for a first CSI report quantity (e.g., normal CSI and/or beam reporting including CRI, SSBRI, RI, PMI, and/or CQI, etc.). A second CPU occupation type (e.g., one or more of CPU occupation type 1, 2, and/or 3) may be used for a second CSI report quantity (e.g., AI/ML CSI and/or beam reporting including beam indication based on Set A and/or measurement of Set B in spatial domain, beam prediction in time domain, CSI compression, CSI prediction, and/or positioning prediction, etc.).

CSI report type: a first CPU occupation type (e.g., CPU occupation type 1 and/or 2) may be used for a first CSI report type (e.g., periodic and/or semi-persistent CSI). A second CPU occupation type (e.g., CPU occupation type 2) may be used for a second CSI report type (e.g., aperiodic CSI).

CSI report config type: a first CPU occupation type (e.g., CPU occupation type 1 and/or 2) may be used for a first CSI report configuration type (e.g., non-AI/ML CSI config). A second CPU occupation type (e.g., one or more of CPU occupation type 1, 2, 3, 4, 5, 6 and/or 7) may be used for a second CSI report configuration type (e.g., AI/ML CSI configuration).

RS transmission type: a first CPU occupation type (e.g., one or more of CPU occupation type 1, 3, and/or 5) may be used for a CSI report config associated with a first RS transmission type (e.g., periodic and/or semi-persistent CSI-RS). A second CPU occupation type (e.g., CPU occupation type 2 and/or 4) may be used for a second CSI report config associated with a second RS transmission type (e.g., aperiodic CSI-RS).

Number of RS resources: a first CPU occupation type (e.g., CPU occupation type 1 and/or 2) may be used for a CSI report configuration associated with a first number of RS resources smaller than (or equal to) X3. A second CPU occupation type (e.g., one or more of CPU occupation type 3, 4, 5, 6, and/or 7) may be used for a second CSI report config associated with a second number of RS resources larger than X3.

Number of RS ports: a first CPU occupation type (e.g., CPU occupation type 1 and/or 2) may be used for a CSI report config associated with a first number RS ports smaller than (or equal to) X4. A second CPU occupation type (e.g., one or more of CPU occupation type 3, 4, 5, 6, and/or 7) may be used for a second CSI report configuration associated with a second number of RS ports larger than X4. Number of RS ports may be at least one of average, median, maximum, and/or minimum of RS ports associated with each CSI report config. For SSB, a fixed number of RS ports may be predefined (e.g., one or two).

CPU type: a first CPU occupation type (e.g., CPU occupation type 1 and/or 2) may be used for a CSI report config associated with a first CPU type (e.g., O_{CPU} and/or N_{CPU}). A second CPU occupation type (e.g., one or more of CPU occupation type 3, 4, 5, 6, and/or 7) may be used for a second CSI report config associated with a second CPU type (e.g., O′_{CPU} and/or N′_{CPU}).

The WTRU may determine one or more CPU types and corresponding CPU occupation duration based on one or more of the following: the WTRU may determine one or more CPU types (e.g., O_{CPU}/N_{CPU} and/or O′_{CPU}/N′_{CPU}) based on one or more of CSI report config type, CSI report type, and/or CSI report quantity.

A first type of CPU (e.g., O_{CPU}/N_{CPU} for normal CPU type) may be used for a first CSI report config type (e.g., non-AI/ML CSI configuration). A second type of CPU (e.g., O_{CPU}/N_{CPU} for normal CPU type and/or O′_{CPU}/N′_{CPU} for AI/ML CPU type) may be used for a second CSI report config type (e.g., AI/ML CSI configuration).

A first type of CPU (e.g., O_{CPU}/N_{CPU} for normal CPU type) may be used for a first CSI report type (e.g., periodic and/or semi-persistent CSI). A second type of CPU (e.g., O_{CPU}/N_{CPU} for normal CPU type and/or O′_{CPU}/N′_{CPU} for AI/ML CPU type) may be used for a second CSI report type (e.g., aperiodic CSI).

A first type of CPU (e.g., O_{CPU}/N_{CPU} for normal CPU type) may be used for a first CSI report quantity (e.g., normal CSI and/or beam reporting including CRI, SSBRI, RI, PMI, and/or CQI, etc.). A second type of CPU (e.g., O_{CPU}/N_{CPU} for normal CPU type and/or O′_{CPU}/N′_{CPU} for AI/ML CPU type) may be used for a second CSI report quantity (e.g., AI/ML CSI and/or beam reporting including beam indication based on Set A and/or measurement of Set B in spatial domain, beam prediction in time domain, CSI compression, CSI prediction, and/or positioning prediction, etc.).

The WTRU may determine one or more CPU occupation types based on one or more of CSI report config type, CSI report quantity, CSI report type and/or determined CPU types.

For example, in non-AI/ML CSI, a first CPU occupation type (e.g., CPU occupation type 1) may be used for a first CSI report config type (e.g., non-AI/ML CSI config) with a first CSI report type (e.g., periodic/semi-persistent CSI) for the first type of CPU.

A second CPU occupation type (e.g., CPU occupation type 2) may be used for a first CSI report config type (e.g., non-AI/ML CSI config) with a second CSI report type (e.g., aperiodic CSI) for the first type of CPU.

A second CPU occupation type (e.g., CPU occupation type 2) may be used for initial CSI report of a first CSI report config type (e.g., non-AI/ML CSI config) with a third CSI report type (e.g., semi-persistent CSI with PUSCH) for the first type of CPU. For other CSI reports, a first CPU occupation type (e.g., CPU occupation type 1) may be used.

A first CPU occupation type (e.g., CPU occupation type 1) may be used for a second CSI report config type (e.g., AI/ML CSI config) and/or a first CSI report quantity (e.g., up to 4 CRIs/SSBRIs for spatial domain prediction) with a first CSI report type (e.g., periodic/semi-persistent CSI) for the first type of CPU and/or the second type of CPU.

A second CPU occupation type (e.g., CPU occupation type 2) may be used for a second CSI report config type (e.g., AI/ML CSI config) and/or a first CSI report quantity (e.g., up to 4 CRIs/SSBRIs for spatial domain prediction) with a second CSI report type (e.g., aperiodic CSI) for the first type of CPU and/or the second type of CPU.

A second CPU occupation type (e.g., CPU occupation type 2) may be used for initial CSI report of a second CSI report config type (e.g., AI/ML CSI config) and a first CSI report quantity (e.g., up to 4 CRIs/SSBRIs for spatial domain prediction) with a third CSI report type (e.g., semi-persistent CSI with PUSCH) for the first type of CPU. For other CSI reports, a first CPU occupation type (e.g., CPU occupation type 1) may be used.

For example, in BM-Case 1, a first CPU occupation type (e.g., CPU occupation type 1) may be used for a second CSI report config type (e.g., AI/ML CSI config) and/or a second CSI report quantity (e.g., up to 4 CRIs/SSBRIs for each time instance in temporal domain prediction) with a first CSI report type (e.g., periodic/semi-persistent CSI) for the first type of CPU and/or the second type of CPU.

Application of CPU occupation type may be different for each CPU type. A third CPU occupation type (e.g., CPU occupation type 1 and/or 3) may be used for a first type of CPU. For the second type of CPU, a fourth CPU occupation type (e.g., CPU occupation type 4) may be used.

A second CPU occupation type (e.g., CPU occupation type 2) may be used for a second CSI report config type (e.g., AI/ML CSI config) and a second CSI report quantity (e.g., up to 4 CRIs/SSBRIs for each time instance in temporal domain prediction) with a second CSI report type (e.g., aperiodic CSI) for the first type of CPU and/or the second type of CPU.

Application of CPU occupation type may be different for each CPU type. A fifth CPU occupation type (e.g., CPU occupation type 2 and/or 6) may be used for a first type of CPU. For the second type of CPU, a fourth CPU occupation type (e.g., CPU occupation type 4) may be used.

A second CPU occupation type (e.g., CPU occupation type 2) may be used for initial CSI report of a second CSI report config type (e.g., AI/ML CSI config) and a first CSI report quantity (e.g., up to 4 CRIs/SSBRIs for each time instance in temporal domain prediction) with a third CSI report type (e.g., semi-persistent CSI with PUSCH) for the first type of CPU. For other CSI reports, a first CPU occupation type (e.g., CPU occupation type 1) may be used.

Application of CPU occupation type may be different for each CPU type. For initial CSI report, a fifth CPU occupation type (e.g., CPU occupation type 2 and/or 6) may be used for a first type of CPU. For the second type of CPU, a fourth CPU occupation type (e.g., CPU occupation type 4) may be used. For other CSI reports, a third CPU occupation type (e.g., CPU occupation type 1 and/or 3) may be used for a first type of CPU. For the second type of CPU, a fourth CPU occupation type (e.g., CPU occupation type 4) may be used.

For example, in BM-Case 2, a sixth CPU occupation type (e.g., one or more of CPU occupation type 3, 4, and/or 5) may be used for a second CSI report config type (e.g., AI/ML CSI config) and/or a second CSI report quantity (e.g., up to 4 CRIs/SSBRIs for each time instance in temporal domain prediction) with a first CSI report type (e.g., periodic/semi-persistent CSI) for the first type of CPU and/or the second type of CPU.

Application of CPU occupation type may be different for each CPU type. For example, a sixth CPU occupation type (e.g., one or more of CPU occupation type 3, 4, and/or 5) may be used for a first type of CPU. For the second type of CPU, a seventh CPU occupation type (e.g., one or more of CPU occupation type 1, 4, and/or 5) may be used.

An eighth CPU occupation type (e.g., one or more of CPU occupation type 4, 6, and/or 7) may be used for a second CSI report config type (e.g., AI/ML CSI config) and a second CSI report quantity (e.g., up to 4 CRIs/SSBRIs for each time instance in temporal domain prediction) with a second CSI report type (e.g., aperiodic CSI) for the first type of CPU and/or the second type of CPU.

Application of CPU occupation type may be different for each CPU type. An eighth CPU occupation type (e.g., one or more of CPU occupation type 4, 6, and/or 7) may be used for a first type of CPU. For the second type of CPU, a ninth CPU occupation type (e.g., one or more of CPU occupation type 2, 4, and/or 7) may be used.

An eighth CPU occupation type (e.g., one or more of CPU occupation type 4, 6, and/or 7) may be used for initial CSI report of a second CSI report config type (e.g., AI/ML CSI config) and a first CSI report quantity (e.g., up to 4 CRIs/SSBRIs for each time instance in temporal domain prediction) with a third CSI report type (e.g., semi-persistent CSI with PUSCH) for the first type of CPU. For other CSI reports, a sixth CPU occupation type (e.g., one or more of CPU occupation type 3, 4 and 5) may be used.

In a solution, application of CPU occupation type may be different for each CPU type. For initial CSI report, an eighth CPU occupation type (e.g., one or more of CPU occupation type 4, 6, and/or 7) may be used for a first type of CPU. For the second type of CPU, a ninth CPU occupation type (e.g., one or more of CPU occupation type 2, 4, and/or 7) may be used. For other CSI reports, a sixth CPU occupation type (e.g., one or more of CPU occupation type 3, 4, and/or 5) may be used for a first type of CPU. For the second type of CPU, a seventh CPU occupation type (e.g., one or more of CPU occupation type 1, 4, and/or 5) may be used.

The WTRU may determine total occupied CPUs for CSI reporting (e.g., L CPUs) and total occupied CPUs for AI/ML based CSI reporting (e.g., L′CPUs). For example, the WTRU may support N_{CPU} CSI processing units for processing CSI reports and N′_{CPU} CSI processing units for processing AI/ML CSI reports. Based on N_{CPU} and/or N′_{CPU}, the WTRU may determine unoccupied CPUs as N_{CPU}−L for processing CSI reports and N′_{CPU}−L′. If N CSI reports start occupying their respective CPUs on the same OFDM symbol on which N_{CPU}−L CPUs and N′_{CPU}−L′ are unoccupied, where each CSI report n=0, . . . , N−1 corresponds to

$${O}_{CPU}^{( n )} ,$$

the WTRU may not update the N-M requested CSI reports with lowest priority, where 0≤M≤N is the largest value such that

$${\sum }_{n = 0}^{M - 1} {O}_{CPU}^{( n )} \leq {N}_{CPU} - L and {\sum }_{n = 0}^{M - 1} {O}_{CPU}^{′ ( n )} \leq {N}_{CPU}^{′} - {L}^{′}$$

holds.

The WTRU may not add determined

$${O}_{CPU}^{( n )} and / or {O}_{CPU}^{′ ( n )}$$

when associated CSI report is deprioritized and/or ignored. If the nₜₕ CSI report is deprioritized, ignored, and/or not updated, the WTRU may skip adding corresponding

$${O}_{CPU}^{( n )} and / or {O}_{CPU}^{′ ( n )}$$

when the WTRU determines CSI reports to be updated. If the WTRU determines M₁ which satisfies

$${\sum }_{n = 0}^{{M}_{1}} {O}_{CPU}^{( n )} \leq {N}_{CPU} - L$$

then the occupied CPU for AI/ML may be

$${\sum }_{n = 0}^{{M}_{1}} {O}_{CPU}^{′ ( n )} \leq {N}_{CPU}^{′} - {L}^{′} .$$

If the WTRU determines M₂ which satisfies

$${\sum }_{n = 0}^{{M}_{2}} {O}_{CPU}^{( n )} \leq {N}_{CPU}^{′} - {L}^{′}$$

then the occupied CPU for normal CSI may be

$${\sum }_{n = 0}^{{M}_{2}} {O}_{CPU}^{( n )} \leq {N}_{CPU} - L .$$

The WTRU may not add determined

$${O}_{CPU}^{( n )} and / or {O}_{CPU}^{′ ( n )}$$

when one or more of RS resources, RS resource set, and/or CSI reporting resources are the same with other CSI report. If one or more of RS resources, RS resource set, CSI reporting resources of nth CSI report are the same n+1th CSI report and the WTRU already added

$${O}_{CPU}^{( n )} and / or {O}_{CPU}^{′ ( n )}$$

then the WTRU may not add

$${O}_{CPU}^{( n + 1 )} and / or {O}_{CPU}^{′ ( n + 1 )}$$

for CPU calculation.

The WTRU may determine a priority value. The WTRU may determine a priority value based on the following equation:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

where y=0 for aperiodic CSI reports to be carried on PUSCH y=1 for semi-persistent CSI reports to be carried on PUSCH, y=2 for semi-persistent CSI reports to be carried on PUCCH, and/or y=3 for periodic CSI reports to be carried on PUCCH. k=0 for CSI reports carrying L1-RSRP or L1-SINR and k=1 for CSI reports not carrying L1-RSRP or L1-SINR. c is the serving cell index and/or N_{cells} is the value of the higher layer parameter maxNrofServingCells. s is the reportConfigID and/or Ms is the value of the higher layer parameter maxNrofCSI-ReportConfigurations.

A first CSI report is said to have priority over second CSI report if the associated Pri_{iCSI}(y, k, c, s) value is lower for the first report than for the second report.

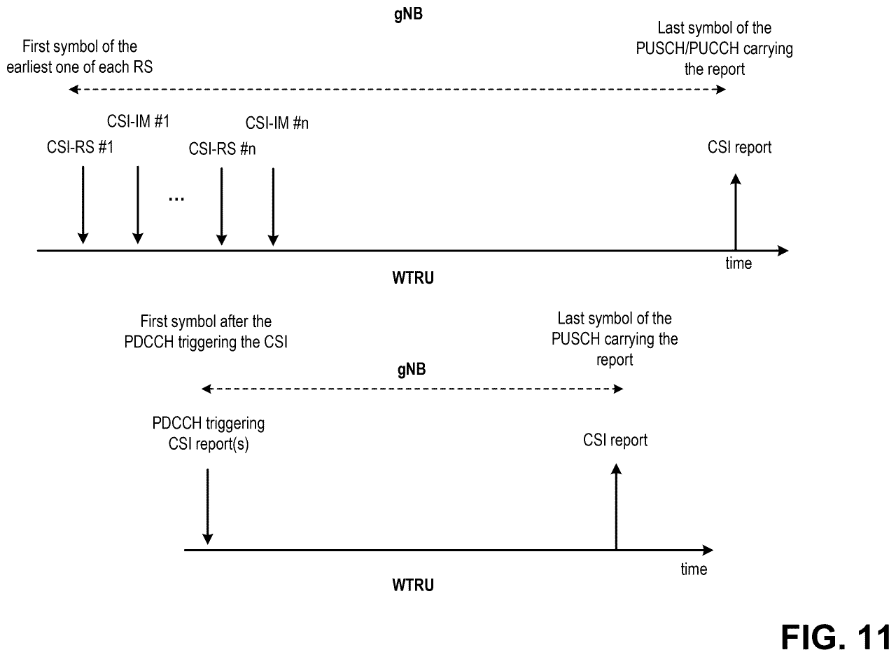

The WTRU may determine one or more CPU types (e.g., O_{CPU} and/or O′CPU) and/or occupation timing based on the activated one or more CSI report configurations and/or corresponding CPU types. If an activated CSI reporting is a normal CSI reporting, the WTRU may determine one or more of the following for CPU occupation: value for O_{CPU} (e.g., value O₀ for O_{CPU}). The WTRU may also determine the duration for CPU occupation. For periodic/semi-persistent CSI, from the first symbol of the earliest of each transmission occasion of periodic or semi-persistent CSI-reference signal (RS)/synchronization signal block (SSB) resource for channel measurement until the last symbol of the configured physical uplink share channel (PUSCH) and/or physical uplink control channel (PUCCH) carrying the report. For an initial semi-persistent CSI report on PUSCH, the duration may last from the first symbol after the physical downlink control channel (PDCCH) triggering the CSI report until the last symbol of the scheduled PUSCH carrying the report. FIG. 11 depicts a CPU for normal CSI and BM-Case 1. As seen in FIG. 11, for aperiodic CSI report, the duration may last from the first symbol after the PDCCH triggering the CSI report until the last symbol of the scheduled PUSCH carrying the report.

If an activated CSI reporting is a first type of AI/ML CSI reporting (e.g., BM Case 1), the WTRU may determine one or more of the following for CPU occupation: value O_{CPU} for N_{CPU} and/or value O′_{CPU} for N′_{CPU} (e.g., value O₁ as O_{CPU} and O₁′ as O′_{CPU}). The WTRU may also determine the duration for CPU occupation (normal CPU occupation). For N_{CPU} and/or O_{CPU}, specifically, for periodic/semi-persistent CSI, the duration may be from the first symbol of the earliest one of each transmission occasion of periodic or semi-persistent CSI-RS/SSB resource for channel measurement until the last symbol of the configured PUSCH and/or PUCCH carrying the report. For an initial semi-persistent CSI report on PUSCH, the duration may be from the first symbol after the PDCCH triggering the CSI report until the last symbol of the scheduled PUSCH carrying the report. For aperiodic CSI report, the duration may be from the first symbol after the PDCCH triggering the CSI report until the last symbol of the scheduled PUSCH carrying the report. For N′_{CPU} and O′_{CPU}, specifically for CSI reporting, the duration may be from before T3 time duration from the first symbol of the configured and/or scheduled PUSCH and/or PUCCH carrying the report until the last symbol of the configured/scheduled PUCCH and/or PUSCH carrying the report.

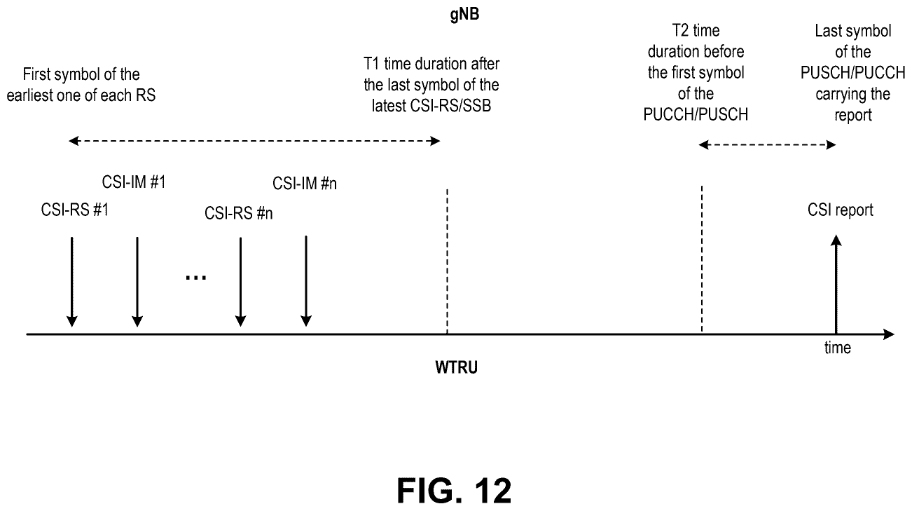

If an activated CSI reporting is a second type of AI/ML CSI reporting (e.g., BM Case 2), then the WTRU may determine one or more of the following for CPU occupation: values for O_{CPU} and/or O′_{CPU} (e.g., value O₂ as O_{CPU} and/or O₂′ as O′_{CPU}). The WTRU may also determine the duration for CPU occupation. For N_{CPU} and/or O_{CPU} the CPU calculation and/or occupation may be only for limited time duration. FIG. 12 depicts CPU occupation for BM-Case 2. As seen in FIG. 12, for RS measurement, the duration may be from the from the first symbol of the earliest one of each transmission occasion of CSI-RS/SSB resource for channel measurement and/or T1 time duration after the last symbol of the latest one of each CSI-RS/SSB for channel measurement. For CSI reporting, from before T2 time duration from the first symbol of the configured and/or scheduled PUSCH and/or PUCCH carrying the report until the last symbol of the configured and/or scheduled PUCCH and/or PUSCH carrying the report.

For CSI reporting, from before T4 time duration from the first symbol of the configured and/or scheduled PUSCH and/or PUCCH carrying the report until the last symbol of the configured and/or scheduled PUCCH/PUSCH carrying the report.

For periodic and/or semi-persistent CSI, the duration may be from the first symbol of the earliest one of each transmission occasion of periodic or semi-persistent CSI-RS/SSB resource for channel measurement until the last symbol of the configured PUSCH and/or PUCCH carrying the report.

For an initial semi-persistent CSI report on PUSCH, the duration may be from the first symbol after the PDCCH triggering the CSI report until the last symbol of the scheduled PUSCH carrying the report.

For aperiodic CSI report, the duration may be from the first symbol after the PDCCH triggering the CSI report until the last symbol of the scheduled PUSCH carrying the report.

The WTRU may apply the determined CPU types and/or the values. The WTRU may update the requested CSI reports beyond CPU capabilities with lowest priority. For normal CSI, the WTRU may update the requested CSI reports when sum of Ns is less than N_{CPU}. For AI/ML CSI, the WTRU may update the requested CSI reports when sum of O_{CPU}s is less than N_{CPU} and/or the sum of O′_{CPU}s is less than N′_{CPU}. The WTRU may not add determined O_{CPU} values for AI/ML CSI when O′_{CPU} is beyond WTRU's capability. The WTRU may not add determined O′_{CPU} values for AI/ML CSI when O_{CPU} is beyond WTRU's capability.

As a benefit, the proposed solution may enable the WTRU to limit CPU occupation from AI/ML BM reporting (especially for BM-Case 2) and/or allowing other legacy CSI processing.

1.-20. (canceled)

21. A wireless transmit/receive unit (WTRU) comprising:
a processor and a memory, the processor configured to:
receive a channel state information (CSI) report configuration, wherein the CSI report configuration comprises one of a plurality of types of CSI report quantity;
send an indication of a first maximum number of channel state information (CSI) processing units (CPUs), wherein the first maximum number of CPUs is associated with a first type of CSI report quantity and a second type of CSI report quantity, and a second maximum number of CPUs, wherein the second maximum number of CPUs is associated with the second type of CSI report quantity;
determine to update a first CSI report of the CSI report configuration that comprises the second type of the one of a plurality of types of CSI report quantity, wherein the determination is based on the first maximum number of CPUs, the second maximum number of CPUs, a first CPU occupation value associated with the CSI report configuration, and a second CPU occupation value associated with the CSI report configuration; and
send the first CSI report based on the determination.

22. The WTRU of claim 21, the processor configured to:
determine a third CPU occupation value and a fourth CPU occupation value, wherein the third CPU occupation value and the fourth CPU occupation value are associated with a second CSI report.

23. The WTRU of claim 22, wherein the first CPU occupation value is associated with the first maximum number of CPUs, and wherein the second CPU occupation value is associated with the second maximum number of CPUs.

24. The WTRU of claim 22, wherein the determination to update the first CSI report of the CSI report configuration comprising a second type of CSI report quantity is based on the first CPU occupation value being less than a difference between the first maximum number of CPUs and the third CPU occupation value and the second CPU occupation value being less than the difference between the second maximum number of CPUs and the fourth CPU occupation value.

25. The WTRU of claim 21, wherein the first type of CSI report quantity is associated with a non-predicted CSI report quantity and the second type of CSI report quantity is associated with predicted CSI report quantity.

26. The WTRU of claim 25, wherein the non-predicted CSI report quantity comprises one or more of a CSI reference signal resource indicator (CRI), synchronization signal block resource indicator (SSBRI), layer-1 reference signal received power (L1-RSRP), rank indicator (RI), precoding matrix indicator (PMI), or channel quality indicator (CQI).

27. The WTRU of claim 26, wherein the predicted CSI report quantity comprises one or more of predicted CSI reference signal resource indicator (p-CRI), predicted synchronization signal block resource indicator (p-SSBRI), or predicted layer-1 reference signal received power (p-L1-RSRP).

28. The WTRU of claim 25, the processor configured to:
send an indication of the first CPU occupation value and the second CPU occupation value for predicted CSI report quantity.

29. The WTRU of claim 21, wherein the CSI report configuration further comprises one or more of an indication of a CSI report type, an indication of CSI report codebook configuration, or a CSI report frequency.

30. The WTRU of claim 29, wherein the CSI report type is one or more of an aperiodic reporting, a semi-persistent reporting, or a periodic reporting.

31. A method implemented by a wireless transmit/receive unit (WTRU), the method comprising:
receiving a channel state information (CSI) report configuration, wherein the CSI report configuration comprises one of a plurality of types of CSI report quantity;
sending an indication of a first maximum number of channel state information (CSI) processing units (CPUs), wherein the first maximum number of CPUs is associated with a first type of CSI report quantity and a second type of CSI report quantity, and a second maximum number of CPUs, wherein the second maximum number of CPUs is associated with the second type of CSI report quantity;
determining to update a first CSI report of the CSI report configuration that comprises the second type of the one of a plurality of types of CSI report quantity, wherein the determination is based on the first maximum number of CPUs, the second maximum number of CPUs, a first CPU occupation value associated with the CSI report configuration, and a second CPU occupation value associated with the CSI report configuration; and
sending the first CSI report based on the determination.

32. The method of claim 31, the method further comprising:
determining a third CPU occupation value and a fourth CPU occupation value, wherein the third CPU occupation value and the fourth CPU occupation value are associated with a second CSI report.

33. The method of claim 32, wherein the first CPU occupation value is associated with the first maximum number of CPUs, and wherein the second CPU occupation value is associated with the second maximum number of CPUs.

34. The method of claim 32, wherein the determination to update the first CSI report of the CSI report configuration comprising a second type of CSI report quantity is based on the first CPU occupation value being less than a difference between the first maximum number of CPUs and the third CPU occupation value and the second CPU occupation value being less than the difference between the second maximum number of CPUs and the fourth CPU occupation value.

35. The method of claim 31, wherein the first type of CSI report quantity is associated with a non-predicted CSI report quantity and the second type of CSI report quantity is associated with predicted CSI report quantity.

36. The method of claim 35, wherein the non-predicted CSI report quantity comprises one or more of a CSI reference signal resource indicator (CRI), synchronization signal block resource indicator (SSBRI), layer-1 reference signal received power (L1-RSRP), rank indicator (RI), precoding matrix indicator (PMI), or channel quality indicator (CQI).

37. The method of claim 36, wherein the predicted CSI report quantity comprises one or more of predicted CSI reference signal resource indicator (p-CRI), predicted synchronization signal block resource indicator (p-SSBRI), or predicted layer-1 reference signal received power (p-L1-RSRP).

38. The method of claim 35, the method further comprising:
sending an indication of the first CPU occupation value and the second CPU occupation value for predicted CSI report quantity.

39. The method of claim 31, wherein the CSI report configuration further comprises one or more of an indication of a CSI report type, an indication of CSI report codebook configuration, or a CSI report frequency.

40. The method of claim 39, wherein the CSI report type is one or more of an aperiodic reporting, a semi-persistent reporting, or a periodic reporting.
